(19) United States
(12) Patent Application Publication
(10) Pub. No.: US 2013/0224408 A1
(43) Pub. Date: Aug. 29, 2013

(54) KNIT SLEEVE FOR AN OIL DIP STICK TUBE, COMBINATION THEREOF, METHOD OF CONSTRUCTION THEREOF AND METHOD OF DAMPENING THE VIBRATION OF AN OIL DIP STICK TUBE

(71) Applicants: Cassie M. Malloy, Blue Bell, PA (US); Christophe Brassenx, West Bloomfield, MI (US); Zhonghuai Zhang, Pottstown, PA (US); Linwood Ludy, Pottstown, PA (US); Tianqi Gao, Exton, PA (US)

(72) Inventors: Cassie M. Malloy, Blue Bell, PA (US); Christophe Brassenx, West Bloomfield, MI (US); Zhonghuai Zhang, Pottstown, PA (US); Linwood Ludy, Pottstown, PA (US); Tianqi Gao, Exton, PA (US)

(21) Appl. No.: 13/403,518

(22) Filed: Feb. 23, 2012

(51) Int. Cl. B32B 1/08; B29C 71/02; D04B 1/22

(52) U.S. Cl. 428/35.2; 66/202; 66/170; 264/345

(57) ABSTRACT

A knit sleeve for an oil dip stick tube, combination thereof, method of construction thereof and method of dampening the vibration of an oil dip stick tube is provided. The knit sleeve includes a circumferentially continuous, closed knit tubular wall extending between opposite ends with a pair of end sections adjacent the opposite ends and a midsection extending between the end sections. The end sections include heat-shrinkable yarn to allow the end sections to be heat-shrunk into a fixed relation about the oil dip stick tube. The midsection includes generally rigid, circumferentially extending, non-heat-shrinkable yarn to maintain the midsection having a circular configuration about the oil dip stick tube with an annular gap extending between the oil dip stick tube and an inner surface of the midsection.

### BACKGROUND OF THE INVENTION

1. Technical Field

This invention relates generally to oil dip stick tubes, and more particularly to apparatus and methods for reducing the vibration frequency of oil dip stick tubes.

2. Related Art

Vehicle oil dip stick tubes are generally lengthy tubes that extend from a crankcase of an engine upwardly to a location that is readily accessible. An oil dip stick is slidably received in the dip stick tube so that the dip stick can be removed from the tube to indicate the oil level in the crankcase. In modern engines, wherein room beneath a hood of the vehicle is sparse, the oil dip stick tube typically traverses one or more bends over a number of feet, thereby being routed about engine components in close proximity to one another. Modern engines are constantly being developed to enhance fuel economy. Some engines have been developed to operate at certain speeds with all the engine cylinders functioning, while at other speeds, typically highway speeds, less than all the cylinders are functioning. As such, the engine produces a variety of harmonic frequencies in use. The varying harmonic frequencies typically transmit throughout the engine, and thus, the various components of the engine must be able to withstand the different frequencies. This includes the oil dip stick tube.

With the dip stick tube being lengthy and hollow, the tube is known to be affected by the changing harmonic frequencies by being caused to vibrate. In some cases, the vibration of the tube can be violent, and thus, can lead to premature failure. As such, in applications where it has been determined that the dip stick tube needs to be dampened, it is known to apply a silicone-titanium based foam sleeve around predetermined areas of the tube and to use a tie-wrap, also referred to as a T-strap, to secure the foam sleeve onto the tube. Although the sleeves tend to offer sufficient dampening to the locations about which they are applied, they are cumbersome to install, which adds to the manufacturing cost of the vehicle. In addition, the sleeves are generally unsightly, which is not desirable to a person buying a new vehicle. In addition, the sleeves need to be custom fit to individual applications to ensure the location desired is being dampened, which also adds to the total cost of manufacture.

A knit textile sleeve manufactured in accordance with the invention overcomes the disadvantages of the foam sleeves discussed above.

### SUMMARY OF THE INVENTION

A knit sleeve for an oil dip stick tube is provided. The knit sleeve includes a circumferentially continuous, closed knit tubular wall extending between opposite ends with a pair of end sections adjacent the opposite ends and a midsection extending between the end sections. The end sections include heat-shrinkable yarn to allow the end sections to be heat-shrunk into fixed relation about the oil dip stick tube. The midsection includes generally rigid, circumferentially extending, non-heat-shrinkable yarn to maintain the midsection having a circular configuration about the oil dip stick tube.

In accordance with another aspect of the invention, a knit sleeve in combination with a vehicle oil dip stick tube configured for sliding receipt of an oil dip stick therein is provided. The knit sleeve includes a circumferentially continuous, closed knit tubular wall extending between opposite ends with a pair of end sections adjacent the opposite ends and a midsection extending between the end sections. The end sections includes heat-shrinkable yarn to allow the end sections to be heat-shrunk into fixed relation about the oil dip stick tube. The midsection includes generally rigid, circumferentially extending, non-heat-shrinkable yarn to maintain a circular configuration of the midsection about the oil dip stick tube.

In accordance with another aspect of the invention, a method of dampening the vibration of an oil dip stick tube is provided. The method includes providing an oil dip stick tube; disposing a knit sleeve about the oil dip stick tube with the knit sleeve having a midsection with an inner diameter greater than an outer diameter of the oil dip stick tube; and heat shrinking end sections of the knit sleeve into fixed relation with the oil dip stick tube without substantially shrinking the inner diameter of the midsection.

### BRIEF DESCRIPTION OF THE DRAWINGS

These and other aspects, features and advantages of the invention will become readily apparent to those skilled in the art in view of the following detailed description of the presently preferred embodiments and best mode, appended claims, and accompanying drawings, in which:

FIG. 1 is a plan view of a knit tubular sleeve constructed in accordance with one presently preferred embodiment of the invention;

FIG. 1A is a plan view of a knit tubular sleeve constructed in accordance with another presently preferred embodiment of the invention;

FIG. 2 is a perspective view of the sleeve of FIG. 1 shown disposed about an oil dip stick tube;

FIG. 3 is a cross-sectional view taken generally along the line 3-3 of FIG. 2;

FIG. 4 is a cross-sectional view taken generally along the line 4-4 of FIG. 2 showing the sleeve in generally concentric relation to the oil dip stick tube;

FIG. 4A is view similar to FIG. 4 showing the sleeve in eccentric abutment with the oil dip stick tube;

FIG. 5 is a hybrid yarn formed in accordance with one embodiment for use in construction of the sleeve;

FIG. 5A is a hybrid yarn formed in accordance with another embodiment for use in construction of the sleeve;

FIG. 6 is a knit stitch utilized in construction of a midsection of the sleeve in accordance with one aspect of the invention; and

FIG. 7 is a knit stitch utilized in construction of the midsection of the sleeve in accordance with another aspect of the invention.

### DETAILED DESCRIPTION OF PREFERRED EMBODIMENTS

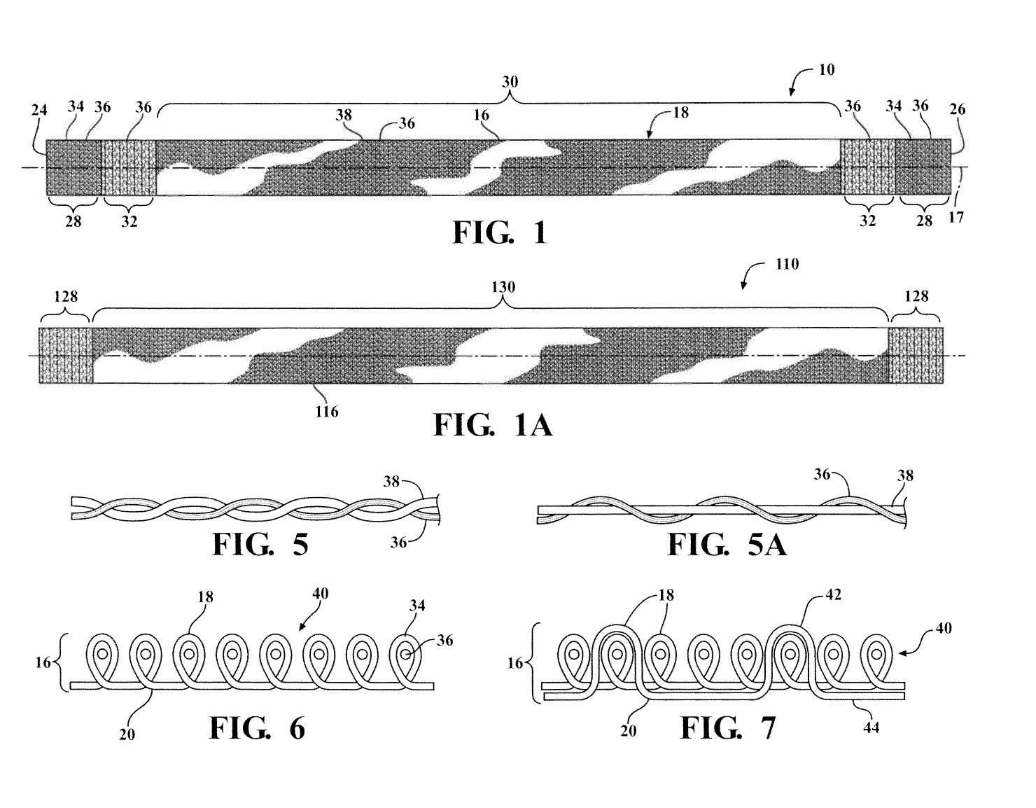

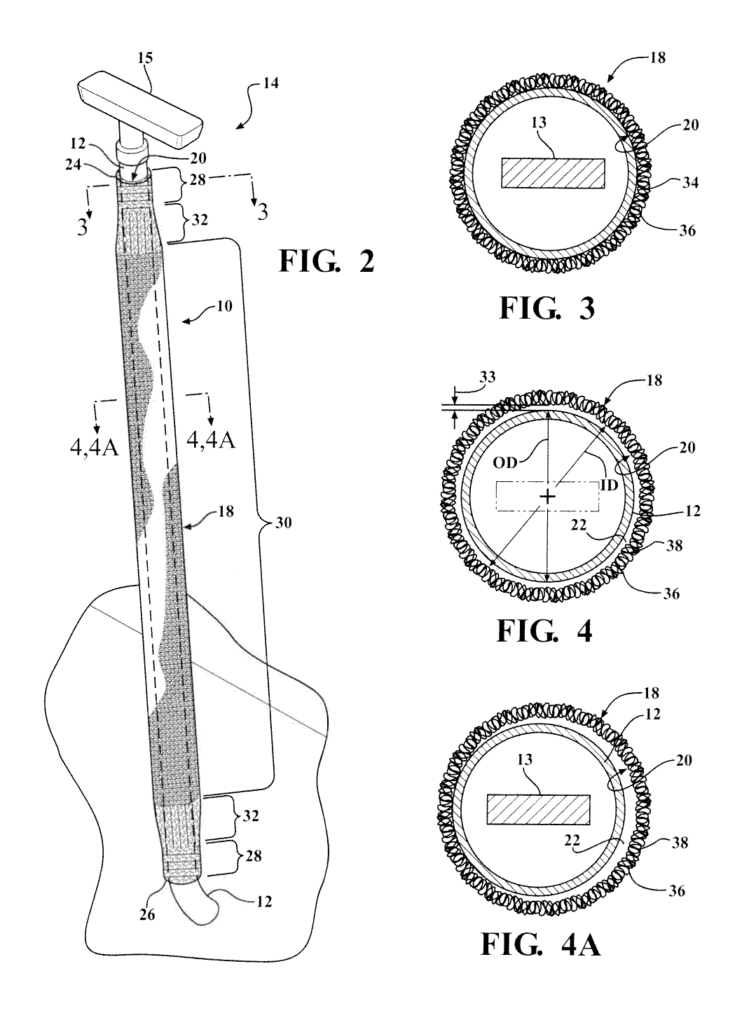

Referring in more detail to the drawings, FIG. 1 illustrates a circumferentially continuous knit tubular textile sleeve 10 constructed according to one presently preferred embodiment of the invention. As shown in FIG. 2, the sleeve 10 is constructed to be easily disposed about an oil dip stick tube, referred to hereafter as tube 12, which is configured for slideable receipt of an oil dip stick 13, and subsequently fixed thereto to form an oil dip stick tube and sleeve assembly, referred to hereafter as assembly 14, to dampen the harmonic frequency of the tube 12 in a running vehicle. The sleeve 10 extends along a sufficient portion of the tube 12 to perform its dampening function, such as between about 7-12 inches, by way of example and without limitation. The sleeve 10 is shown here as extending along a substantially straight portion of the tube 12 starting immediately adjacent an end of the tube 12 below a dipstick handle 15. As such, the sleeve 10 is typically in plain view beneath a hood of the vehicle. By dampening the frequency of the tube 12 with the sleeve 10, the tube 12 is prevented from vibrating at frequencies which could otherwise cause damage to the tube 12, including failure. Accordingly, the tube 12 is able to function, as intended, over the full useful life of the vehicle. Aside from preventing the tube 12 from vibrating at potentially damaging frequencies, the sleeve 10 is aesthetically pleasing and easy to assemble about the tube 12 in manufacture, as discussed further below. Accordingly, the assembly 14 is economical in both manufacture and assembly.

The textile sleeve 10 has a plurality of yarns interlaced via a knitting process with one another to form a closed, circumferentially continuous wall 16 extending along a longitudinal axis 17. The wall 16 has an outer surface 18 and an inner surface 20 bounding a cavity 22 extending axially along the longitudinal axis 16 between opposite ends 24, 26 of the sleeve 10. The wall 16 has a plurality of discrete circumferential band-shaped sections extending axially along the axis 17, including at least two end sections 28 extending from the opposite ends 24, 26 and an intermediate section, also referred to as midsection 30, between the end sections 28. Further, the wall 16, as shown in FIGS. 1 and 2, includes a pair of transition sections 32, with each transition section 32 extending axially between a separate one of the end sections 28 and the midsection 30. The different sections 28, 30, 32 function differently from one another to provide the sleeve 10 with its ability to remain both axially fixed to the tube 12, while also remaining free along the midsection 30 to move radially relatively to the tube 12 to dampen the vibration frequency of the tube 12 in use.

In particular, it is necessary that the end sections 28 are knit via yarn(s) that allow the end sections 28 to be heat-shrunk into fixed contact with the tube (FIG. 3). It is further necessary to knit the midsection 30, at least in part, via generally stiff, circumferentially extending yarn(s) that take on a rigid, generally circular shape having an “as assembled” first density with an inner surface having an inner diameter (ID) that is greater than an outer diameter (OD) of the tube 12. Accordingly, an annular gap 33 (FIG. 4) extending between an outer surface of the oil dip stick tube 12 and an inner surface of the midsection 30. Further, when incorporated, it is necessary that the transition sections 32 be knit via non-heat-shrinkable yarn(s) that form a loosely knit, generally frustroconical flexible structure, upon heat-shrinking the end sections 28, having a second density that is less than the first density of the midsection 30, thereby allowing the relatively rigid circular midsection 30 to move or float freely or substantially freely radially relative to the end sections 28 and the tube 12, as needed to dampen vibration of the tube 12.

In one presently preferred embodiment, by way of example and without limitation, the entire sleeve wall 16 is knit in a full jersey knit pattern, though it should be recognized that any suitable pattern or combination of patterns could be used, such as interlock and/or various rib patterns. Further, the end sections 28 are knit via two different types of yarn, including a heat shrinkable yarn 34, such as a 0.38 mm heat shrinkable monofilament, and a 1250 denier PET multifilament 36, for example. It should be recognized that the end sections 28 could be knit from a single heat-shrinkable yarn type, but it is critical that at least one heat-shrinkable yarn be used in the end sections 28. The heat-shrinkable yarn 34 provides the end sections 28 with their ability to be heat-shrunk during assembly, thereby fixing the sleeve 10 against relative axial movement with the tube 12.

The midsection 30 is knit via two types of yarn, including the 1250 denier PET multifilament 36 used in the end sections 28 along with a relatively rigid monofilament 38, such as can be provided via a hybrid yarn 39 including both the multifilament 36 and monofilament 38 being twisted with one another (FIG. 5), or with the multifilament 36 being served (FIG. 5A) about the monofilament 38, by way of example and without limitation. In one example, the hybrid yarn was provided having a 7500 denier PET multifilament 36 for increased weight and cushion and a 0.38 mm PET monofilament 38 for circular rigidity, for example. The increased weight provides an important function of facilitating relative movement between the midsection 30 and the tube 12, while the cushion provides an important function of dampening and thus, preventing audible noise from being produced when the midsection 30 impacts the tube 12 during use. It should be recognized that a single yarn or any plurality of yarns could be used as long as the midsection 30 is formed as a relatively rigid circular sleeve, having generally rigid, circumferentially extending, non-heat-settable yarn to substantially non-heat-settable yarn, thereby maintaining its circular configuration, that is capable of producing little or no audible noise upon impacting the tube 12.

In FIG. 6, one type of knit stitch pattern is shown, i.e. full jersey, wherein the stitch used is a knit stitch 40, as opposed to a tuck stitch and float stitch. In FIG. 7, another type of knit stitch pattern is shown, wherein the knit stitch pattern is generally the same type as in FIG. 6, i.e. jersey, however, the stitch type is different in that it includes both a knit stitch 40, a tuck stitch 42 and a float stitch 44. The benefit obtained by incorporating the tuck and float stitches 42, 44 is in the ability to further increase the density, rigidity and cushion of the midsection 30. The tuck stitches 42 provide the outer surface 18 with a uniform, aesthetically pleasing appearance, while the float stitches 44 provide the inner surface 20 with an increased density and cushion, thereby acting to minimize the amount of noise generated as the wall 16 impacts the tube 12 in use.

The transition sections 32 are knit entirely via a flexible, non-heat-shrinkable yarn, such as the 1250 denier PET multifilament 36, for example. Due to the yarn 36 being non-heat-shrinkable, the transition sections 32 are not caused to shrink or substantially shrink during application of heat to the heat-shrinkable end sections 28. As such, the transition sections 32 remain flexible to extend from the reduced diameter of the heat-shrunk end sections 28 radially outwardly to the increased diameter midsection 30, thereby taking on its generally frustroconical configuration. Further yet, with the transitions sections 32 being knit having relatively large knit stitches as compared to the mote tightly knit stitches used to form the end sections 28 and the midsection 30, the transition sections 32 are able to remain highly flexible, as required, to allow relative radial movement between the midsection 30 and the end sections 28. The enlarged knit stitches forming the transition sections 32 cause the transition sections 32 to have a significantly reduced density compared to both the midsection 30 and the end sections 28. The enlarged stitch used to construct the transition sections 32 is performed primarily by controlling the needle height and the take-up tension, wherein the greater the needle height and greater the needle tension, the greater the size of the stitch formed, thereby providing a low density knit pattern. Accordingly, although the same knit stitch pattern can be used to construct the entire sleeve 10, the different performance characteristics desired over the length of the sleeve 10 can be at least partially controlled by varying the size of the knit stitches within the respective sections 28, 30, 32. Of course, the type of yarn material used, as discussed above, also plays a critical role in the performance characteristics of the different sections 28, 30, 32 of the sleeve 10.

In FIG. 1A, a sleeve 110 constructed in accordance with another aspect of the invention is shown, wherein the same reference numerals as used above, offset by a factor of 100, are used to identify like features. The sleeve 110 is similar to the sleeve 10 described above, however, it does not include transition sections. As such, the sleeve 110 has end sections 128 and a midsection 130, with the end sections 128 being knitted directly to the midsection 130. The same yarns, knit patterns and knit stitches can be used to form the end sections 128 and a midsection 130 as described above for the corresponding end sections 28 and midsection 30, and thus, this detail is not repeated here. The notable difference with the sleeve 110 in contrast with the sleeve 10, is with its slightly reduced ability of the midsection 130 to move radially freely relative to the end sections 128 and tube 12, particularly in the regions immediately adjacent the end sections 128, given it lacks the low density, non-heat shrunk transition sections 32. Accordingly, although useful to perform the function of reducing the harmonic frequency of the dip tube 12, it is understood to be less effective than the sleeve 10 including the transition sections 32.

In accordance with a further aspect of the invention, a method of constructing a knit sleeve 10, 110 configured to cover at least a portion of an oil dip stick tube 12 is provided. The method includes knitting a circumferentially continuous, closed tubular wall 16, 116 as described above, having a pair of end sections 28, 128 including heat-shrinkable yarn to allow the end sections 28, 128 to be heat-shrunk into fixed relation about the oil dip stick tube 12 and having a midsection 30, 130 extending between the end sections 28, 128 with the midsection 30, 130 including generally rigid, circumferentially extending, substantially non-heat-shrinkable yarn.

The method can further include knitting transition sections 32, as described above, extending between the end sections 28 and the midsection 30 with the transition sections 32 being highly flexible and having a knit stitch density less than the midsection 30. This allows the midsection 30 to substantially float radially relative the end sections 28 upon fixing the end sections 28 to the oil dip stick tube 12.

In accordance with a further aspect of the invention, a method of dampening the vibration of an oil dip stick tube 12 is provided. The method includes providing the oil dip stick tube 12 and disposing a knit sleeve 10, 110, constructed as described above, about the oil dip stick tube 12 with the knit sleeve 10, 110 having a midsection 30, 130 with an inner diameter ID greater than an outer diameter OD of the oil dip stick tube 12. Further, heat shrinking end sections 28, 128 of the knit sleeve 10, 110 into fixed relation with the oil dip stick tube 12 without substantially shrinking the inner diameter ID of the midsection 30, 130.

The method of dampening can further include providing flexible transition sections between the midsection 30 and the end sections 28. This provides enhanced dampening of the oil dip stick tube 12 by allowing the midsection 30 to float radially relative to the fixed end sections 28, thereby allowing the midsection 30 to randomly impact the oil dip stick tube 12 during use (FIG. 4A). The periodic impact of the relatively soft midsection 30 with the oil dip stick tube 12 dampens the vibration of the oil dip stick tube 12, thereby greatly reducing the potential for damage thereto.

It should be recognized that sleeves 10, 110 constructed in accordance with the invention are suitable for use in applications other than dip stick tubes. For example, they could be used in automotive, marine, industrial, aeronautical or aerospace applications, or any other application wherein protective sleeves are desired to be fixed against axial movement relative the elongate member being protected, while at the same time having a relatively rigid midsection sized for radial clearance about the elongate member being protected.

Obviously, many modifications and variations of the present invention are possible in light of the above teachings. It is, therefore, to be understood that within the scope of the appended claims and any claims allowed that are related in any way to this application, that the invention may be practiced in ways other than described above and illustrated

What is claimed is:

1. A knit sleeve for an oil dip stick tube, comprising:
a circumferentially continuous, closed knit tubular wall extending between opposite ends with a pair of end sections adjacent said opposite ends and a midsection extending between said end sections, said end sections including heat-shrinkable yarn to allow said end sections to be heat-shrunk into fixed relation about the oil dip stick tube, said midsection including generally rigid, circumferentially extending, substantially non-heat-shrinkable yarn.

2. The knit sleeve of claim 1 further including transition sections extending between said end sections and said midsection, said transition sections being knit entirely from non-heat-shrinkable yarn.

3. The knit sleeve of claim 2 wherein said transition sections are knit having a knit stitch density less than said midsection.

4. The knit sleeve of claim 3 wherein said transition sections are knit entirely from multifilament yarn.

5. The knit sleeve of claim 1 wherein said midsection is knit from monofilament yarn and multifilament yarn.

6. The knit sleeve of claim 5 wherein said multifilament yarn is knit having float stitches on an inner surface of said wall.

7. The knit sleeve of claim 1 wherein said end sections are knit from heat-shrinkable monofilament yarn and multifilament yarn.

8. A knit sleeve in combination with a vehicle oil dip stick tube configured for sliding receipt of an oil dip stick therein, comprising:
a circumferentially continuous, closed knit tubular wall extending between opposite ends with a pair of end sections adjacent said opposite ends and a midsection extending between said end sections, said end sections including heat-shrinkable yarn allowing said end sections to be heat-shrunk into fixed relation about an outer surface of said oil dip stick tube, said midsection including generally rigid, circumferentially extending, substantially non-heat-shrinkable yarn having an inner surface with a diameter greater than a diameter of said outer surface of said oil dip stick tube.

9. The combination of claim 8 further including transition sections extending between said end sections and said midsection, said transition sections being knit having a knit stitch density less than said midsection.

10. The combination of claim 9 wherein said transition sections are knit entirely from non-heat-shrinkable yarn.

11. The combination of claim 10 wherein said transition sections are knit entirely from multifilament yarn.

12. The combination of claim 8 wherein said midsection is knit from monofilament yarn and multifilament yarn.

13. The combination of claim 12 wherein said multifilament yarn is knit having float stitches on an inner surface of said wall.

14. The combination of claim 8 wherein said end sections are knit from monofilament yarn and multifilament yarn.

15. A method of constructing a knit sleeve configured to cover at least a portion of an oil dip stick tube, comprising:
knitting a circumferentially continuous, closed tubular wall having a pair of end sections including heat-shrinkable yarn to allow the end sections to be heat-shrunk into fixed relation about the oil dip stick tube and having a midsection extending between the end sections with the midsection including generally rigid, circumferentially extending, substantially non-heat-shrinkable yarn.

16. The method of claim 15 further including knitting transition sections extending between the end sections and the midsection with the transition sections having a knit stitch density less than the midsection.

17. The method of claim 15 further including knitting transition sections extending between the end sections and the midsection with the transition sections being knit entirely from non-heat-shrinkable yarn.

18. The method of claim 17 further including knitting the transition sections entirely from multifilament yarn.

19. A method of dampening the vibration of an oil dip stick tube, comprising:
providing an oil dip stick tube;
disposing a knit sleeve about the oil dip stick tube with the knit sleeve having a midsection with an inner diameter greater than an outer diameter of the oil dip stick tube; and
heat shrinking end sections of the knit sleeve into fixed relation with the oil dip stick tube without substantially shrinking the inner diameter of the midsection.

20. The method of claim 19 further including providing flexible transition sections between the midsection and the end sections.

21. The method of claim 20 further including forming the transition sections entirely of non-heat-shrinkable yarn.
